(19) United States
(12) Patent Application Publication
(10) Pub. No.: US 2006/0054872 A1
(43) Pub. Date: Mar. 16, 2006

(54) Nuclear fuel

(75) Inventor: Leszek Andrzej Kuczynski, Pretoria (ZA)

Correspondence Address: SENNIGER POWERS, ONE METROPOLITAN SQUARE, 16TH FLOOR, ST LOUIS, MO, 63102, US

(73) Assignee: Pebble Bed Modular Reactor (Propriety) Limited, Centurion (ZA)

(21) Appl. No.: 11/068,167

(22) Filed: Feb. 28, 2005

(30) Foreign Application Priority Data
Mar. 1, 2004 (ZA) 2004/1666

(51) Int. Cl. C09K 11/04

(52) U.S. Cl. 252/636

(57) ABSTRACT

This invention relates to a method of preparing a nuclear fuel element including the steps of feeding fuel particles and/or a matrix material, in which the fuel particles are to be dispersed, into at least one cavity defined in a body, and reducing the volume of fuel particles and/or matrix material fed Into the cavity by ultrasonic vibration of at least one of the fuel particles, the matrix material and the body. The invention extends to a nuclear fuel element.

This invention relates to nuclear fuel. More particularly, it relates to a method of preparing a nuclear fuel and to a nuclear fuel element.

According to one aspect of the invention, there is provided a method of preparing a nuclear fuel element, which method includes the steps of feeding fuel particles and/or a matrix material, in which the fuel particles are to be dispersed, into at least one cavity defined in a body; and reducing the volume of fuel particles and/or matrix material fed into the cavity by ultrasonic vibration of at least one of the fuel particles, the matrix material and the body.

The ultrasonic vibration may be by means of ultrasonic waves.

Reducing the volume of fuel particles and/or matrix material fed into the cavity may include vibrating at least one of the fuel particles, the matrix material and the body by mechanical forces.

The fuel particles and/or matrix material may be fed into the at least one cavity defined in the body by pulsatory flow.

By “pulsatory flow” is to be understood regular bursts of flow of particles and/or matrix material.

Where the at least one cavity extends through the body and has ends which open out of the body, the method may include the prior step of at least partially closing an open end of the at least one cavity to inhibit flow of fuel particles and/or matrix material out of the at least one cavity. At least partially closing the open end of the at least one cavity may include disposing a fibrous material over the open end. A gauge of the fibrous material will typically be such that the fuel particles and for matrix material cannot pass through the fibrous material.

According to another aspect of the invention, there is provided a method of preparing a nuclear fuel element, which method includes feeding fuel particles and matrix material into at least one cavity defined in a body simultaneously from at least two directions.

The body may be that of a fuel element. Instead, the body may be that of a mould for moulding fuel compacts for insertion into a fuel element.

The fuel particles and matrix material may be fed into the at least one cavity independently. Preferably, the fuel particles and matrix material are fed into the at least one cavity from opposed directions. The fuel particles and matrix material may be fed into the at least one cavity at different rates of flow. More particularly, the rate of flow of the fuel particles may be greater than the rate of flow of the matrix material.

The fuel particles and/or matrix material may be fed into the at least one cavity by continuous flow. Instead, the fuel particles and/or matrix material may be fed into the at least one cavity by pulsatory flow.

The method may include the step of reducing the volume of fuel particles and/or matrix material fed into the at least one cavity. More particularly, the volume of fuel particles and/or matrix material fed into the at least one cavity may be reduced by vibration of at least one of the fuel particles and the body. The vibration may be by means of ultrasonic waves. Instead, or in addition, the vibration may be by means of mechanical forces.

According to still another aspect of the invention, there is provided a nuclear fuel element prepared in accordance with a method as hereinbefore described.

The fuel particles may each include a kernel of fissile material surrounded by a fission product-retentive coating. The matrix material may include a mixture of a phenolic resin and graphite powder.

The invention will now be described, by way of example, with reference to the following Example and the accompanying diagrammatic drawing, which shows a part-sectional perspective view of a nuclear fuel element in accordance with the invention.

### EXAMPLE 1

Fuel particles comprising a kernel of uranium dioxide surrounded by a fission product-retentive coating, including, for example, layers of pyrolytic carbon and silicon carbide, were fed into a plurality of tubular passages, providing cavities, defined within a block-shaped body. Each passage/cavity extends through the body, opening out of its ends. Matrix material comprising a mixture of a phenolic resin and graphite was fed into the tubular passages simultaneously with the fuel particles. In one embodiment the block-shaped body with its cavities filled with fuel particles dispersed in matrix material provides a nuclear fuel element to form part of a core of a nuclear reactor. in another embodiment, the body provides a mould for moulding cylindrical fuel compacts for insertion into a fuel element.

The fuel particles and the body were vibrated by ultrasonic waves during feed of the fuel particles and matrix material thereby to give the closest possible packing of fuel particles in the matrix material and to reduce the volume of the fuel particles/matrix material fed into the cavities of the body.

The coated fuel particles and matrix material were fed by pulsatory flow, regular bursts of fuel particles and matrix material being interspersed with periods of no feed of fuel particles and matrix material.

In one embodiment, the fuel particles and matrix material are vibrated by mechanical forces during feed thereof into the tubular passages.

It is to be appreciated that instead of both the fuel particles and the body being vibrated, one or the other of the fuel particles and the body of the nuclear fuel element may be vibrated.

In one embodiment of the invention, the fuel particles and matrix material, respectively, were fed into the tubular passages from opposed directions at the opposed open ends of the passages, the coated particles being fed into the cavities at a faster rate of flow than the matrix material.

In another embodiment of the invention, in which the fuel particles and matrix material are fed into the tubular passages from one end of the passage only, an opposed open end of each passage is partially closed by a net of fibrous material having a gauge sufficiently small so as to inhibit the flow of fuel particles and matrix material therethrough.

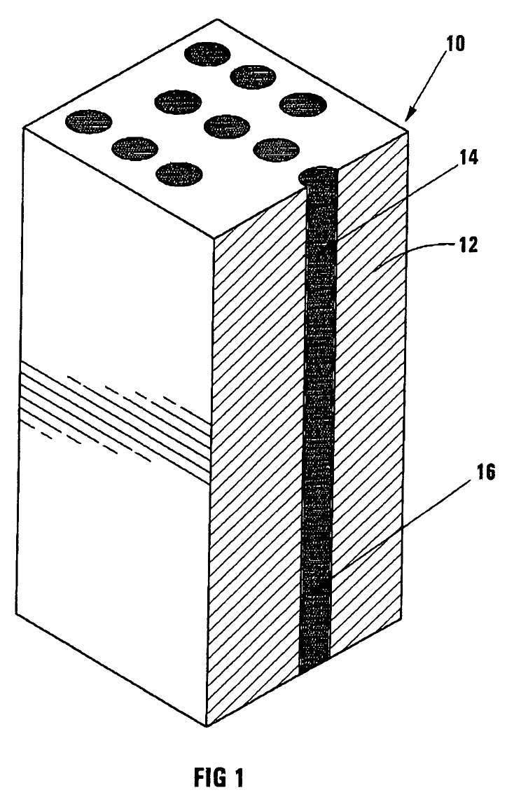

In FIG. 1, reference numeral 10 refers generally to a nuclear fuel element in accordance with the invention. The nuclear fuel element 10 includes a block-shaped graphite body 12 having a plurality of substantially parallel spaced tubular passages 14 extending therethrough and opening out of opposed ends of the body 12. Each passage is filled with a plurality of fuel particles supported in a matrix material, generally indicated by reference numeral 14, the fuel particles and matrix material having been fed into the passages 14 in accordance with the method of Example 1.

### DISCUSSION

Sufficient kinetic energy should be imparted to the fuel particles arid matrix material 16 by means of the pulsating flow and/or bidirectional flow and vibration compacting thereof so as to generate chaotic movements for a period adequate to generate a packing of the required filling density and of low potential energy

The Applicant believes that the method of preparing the nuclear fuel element 10 of the invention will result in improved packing and increased density of packing of filler material, comprising fuel particles in a matrix material, for cavities of a nuclear fuel element.

It is to be appreciated that the method of preparing the fuel element 10 may be applied to the preparation of nuclear fuel elements including only a single passage/cavity or multiple passages.

1. A method of preparing a nuclear fuel element, which method includes the steps of feeding fuel particles and/or a matrix material, in which the fuel particles are to be dispersed, into at least one cavity defined in a body; and reducing the volume of fuel particles and/or matrix material fed into the cavity by ultrasonic vibration of at least one of the fuel particles, the matrix material and the body.

2. A method as claimed in claim 1, in which the ultrasonic vibration is by means of ultrasonic waves.

3. A method as claimed in, claim 1, in which reducing the volume of fuel particles and/or matrix material fed into the cavity includes vibrating at least one of the fuel particles, the matrix material and the body by mechanical forces.

4. A method as claimed in claim 1 in which the fuel particles and/or matrix material are fed into the at least one cavity defined in the body by pulsatory flow.

5. A method as claimed in claim 1, which includes, where the at least one cavity extends through the body and has ends which open out of the body, the prior step of at least partially closing one open end of the at least one cavity to inhibit flow of fuel particles and/or matrix material out of the at least one cavity.

6. A method as claimed in claim 5, in which at least partially closing the one open end of the at least one cavity includes disposing a fibrous material over said open end.

7. A method as claimed in claim 6, in which the fibrous material is of a gauge such that the fuel particles and/or matrix material cannot pass through the fibrous material.

8. A method as claimed in claim 1, which includes feeding fuel particles and matrix material into the at least one cavity defined in the body simultaneously from at least two directions.

9. A method as claimed in claim 8, in which the fuel particles and matrix material are fed into the at least one cavity independently.

10. A method as claimed in claim 8, in which the fuel particles and matrix material are fed into the at least one cavity from opposed directions.

11. A method as claimed in claim 8, in which the fuel particles and matrix material are fed into the at least one cavity at different rates of flow,

12. A method as claimed in claim 11, in which the rate of the flow of the fuel particles is greater than the rate of flow of the matrix material.

13. A method of preparing a nuclear fuel element, which method includes feeding fuel particles and matrix material into at least one cavity defined in a body simultaneously from at least two directions.

14. A method as claimed in claim 13, in which the fuel particles and matrix material are fed into the at least one cavity independently.

15. A method as claimed in claim 13, in which the fuel particles and matrix material are fed into the at least one cavity from opposed directions.

16. A method as claimed in claim 13, in which the fuel particles and matrix material are fed into the at least one cavity at different rates of flow.

17. A method as claimed in claim 16, in which the rate of flow of the fuel particles is greater than the rate of flow of the matrix material.

18. A method as claimed in claim 13, in which the fuel particles and/or matrix material are fed into the at least one cavity by continuous flow.

19. A method as claimed in claim 13, in which the fuel particles and/or matrix material are fed into the at least one cavity by pulsatory flow.

20. A method as claimed in claim 13, which includes the step of reducing the volume of fuel particles and/or matrix material fed into the at least one cavity.

21. A method as claimed in claim 20, in which the volume of fuel particles and/or matrix material fed into the at least one cavity is reduced by vibration of at least one of the fuel particles and the body.

22. A method as claimed in claim 21, in which the vibration is by means of ultrasonic waves.

23. A method as claimed in claim 2L in which the vibration is by means of mechanical forces.

24. A nuclear fuel element prepared in accordance with a method as claimed in claim 1.

25. A nuclear fuel element as claimed in claim 24, in which the fuel particles each include a kernel of fissile material surrounded by a fission product-retentive coating.

26. A nuclear fuel element as claimed in claim 24, in which the matrix material includes a mixture of a phenolic resin and graphite powder.
